(19) United States
(12) Patent Application Publication
(10) Pub. No.: US 2006/0168918 A1
(43) Pub. Date: Aug. 3, 2006

(54) Saddle for horseback riding

(76) Inventors: Christina Naslund, Orsundsbro (SE); Per Martin Andren, Eds Bruk (SE)

Correspondence Address: YOUNG & THOMPSON, 745 SOUTH 23RD STREET, 2ND FLOOR, ARLINGTON, VA, 22202, US

(21) Appl. No.: 10/537,174

(22) PCT Filed: Dec. 2, 2003
(86) PCT No.: PCT/SE03/01861

§ 371 Date: Dec. 28, 2005

(30) Foreign Application Priority Data
Dec. 2, 2002 (SE) 0203589-7
Dec. 19, 2002 (SE) 0203796-8

(51) Int. Cl. B68C 1/02; B68C 1/08

(52) U.S. Cl. 54/44.1; 54/44.5

(57) ABSTRACT

Saddle (10) for horseback riding, comprising a saddle base (30) that is anatomically adapted to the horseback, and a saddle seat (40), wherein that the saddle seat (40) is detachably arranged on the saddle base (30). The invention further relates to a saddle base (30) for a horseback saddle (10), comprising two pressure distributors (120) that are interconnected by a bridging arrangement (130) that provides clearance over the spinal region, wherein each pressure distributor (120) comprises a rigid section (170) and a peripheral flexing portion (180, 180a, 180b, 180c). Still further the invention relates to a saddle seat (40), a saddle pad (20) and a method of providing a saddle (10).

The present invention relates to a saddle for horseback riding, and in particular to a saddle with increased comfort for both rider and horse.

### BACKGROUND OF THE INVENTION

During the last century only minor changes/improvements have been done on horseback saddles. The saddles of today all have their roots in the western- or the British type saddles that were developed before the 20^{th} century. Both these concepts are mainly focused on the comfort for the rider and only to a minor extent on the carrying comfort for the horse. With respect to the load on the horseback they both represent high loads over a relatively small surface of the horseback. More specifically the load is concentrated on the narrow muscle section that run along the spinal and in the case of British saddles also on the muscular region just rear to the scapular, as they are provided with stabilizing protrusions that put a large pressure there. Such concentrated pressures may actually cause injury to the horse, whereby some of the pressurized muscles can get underdeveloped. Such saddles actually require that the horseback is adapted to the saddle in stead of the opposite. One attempt to spread the pressure over a larger area is presented in U.S. Pat. No. 6,474,052 B2, which discloses a western style saddle provided with extra panels comprising a sheet of padded material (sheepskin) and a sheet of flexationally resistive material (leather). However, as these panels are resilient and do not comprise any elements rigid enough to spread the pressure over a large area, the load on the horseback is still relatively concentrated.

On the other hand another drawback relates to rider comfort, in fact all saddles sold at present has to be “broken in” by the rider, i.e. the rider has to ride for many hours to form the seat of the saddle for best individual comfort. Moreover, if another rider borrows the saddle for a while, the saddle becomes reshaped. There have been attempts to create more versatile saddles that can be adapted to certain riders, or saddles that reshape in a relatively quick manner. EP 1 197 469 A1 disclose a modular saddle concept wherein the seating characteristics can be altered by detachable seat pads.

Another disadvantageous feature of such conventional saddles is the stirrup arrangement. Each stirrup is attached to the saddle by a stirrup strap that in turn is attached to a stirrup bracket on the saddle frame in the front or mid region of the saddle. Hence, when a force is applied on the stirrups a concentrated pressure will arise on the horseback in this region. Furthermore, this arrangement makes it difficult for the rider to find the optimal position on the horse.

The traditional stirrup straps are provided with a standard buckle of the type normally found on a belt for length adjustment, which makes adjustments of stirrup height difficult while on the horseback. U.S. Pat. No. 4,881,303 disclose an alternative stirrup buckle that is simpler to adjust. But, it still suffers from the above disadvantages of applying a point load on the horseback.

Still another problem with existing stirrup arrangements is that the rider may get stuck in the stirrup after falling off the horse. There are several stirrup arrangements that seek to solve this problem, such as U.S. Pat. No. 3,816,974. However, all known systems are based on releasable stirrups that are released from the supporting strap arrangement when a sufficient force is applied on the stirrup, or the like. However, such stirrups may be extremely hazardous as they may release in unwanted situations that can make the rider lose control of the horse.

### SUMMARY OF THE INVENTION

The object of the invention is to provide a new saddle for horseback riding, which saddle overcomes one or more drawbacks of the prior art. This is achieved by the saddle as defined in claim 1, the saddle base of claim 6, the saddle seat of claim 18, the saddle pad of claim 20 and by the method of claim 21.

One advantage with such saddle is that the comfort is increased for both horse and rider, as the saddle base and the saddle seat can be adapted to the horse and the rider, respectively, before they are assembled.

Another advantage is that the saddle spreads out the pressure from the rider over a larger area on the horseback thereby vastly increasing the comfort for the horse.

Still another advantage is that the saddle may be adapted to different riders and/or riding disciplines by attaching different saddle seats on the saddle base, on the same time as the same saddle seat may be used on several horses each with an individually adapted saddle base.

Furthermore, compared with traditionally hand made leather saddles the saddle according to the invention can be produced with efficient methods in relative inexpensive materials, whereby the saddle as a whole will be less expensive to produce, even though the comfort is increased.

Yet another advantage is that the saddle easily may be provided with a stirrup system that spreads the load from the stirrup over essentially the full length of the saddle, whereby increased comfort is achieved for the horse, which stirrup system further spreads the pressure independent of the direction of the load on the stirrup.

Yet another advantage is that the saddle with such a moveable stirrup arrangement ensures a more correct riding position for the rider in all situations.

Yet another advantage is that the saddle with such a stirrup system provides simple and precise height adjustment of the stirrup.

Yet another advantage is that the saddle with such a stirrup system according to another embodiment is provided with a reliable releasing system that provides for safe riding.

Embodiments of the invention are defined in the dependent claims.

### BRIEF DESCRIPTION OF THE DRAWINGS

The invention will be described in detail below with reference to the drawings, in which:

FIG. 1 shows an exploded view of a saddle according to the present invention.

FIG. 2 shows the saddle of FIG. 1 in an assembled state.

FIG. 3 shows the saddle of FIGS. 1 and 2 mounted on a horse.

FIG. 4a shows an example of the saddle of FIG. 1 with a quick fastening system for retaining the saddle seat on the saddle base.

FIG. 4b display the function of the quick fastening structure wherein the saddle seat of the saddle is partly released from the saddle base.

FIG. 5 shows a perspective view of a saddle base according to one embodiment of the present invention.

FIGS. 6a to 6c show the pressure distribution areas for a conventional British type saddle, western type saddle and a saddle according to the present invention, respectively.

FIG. 7 shows the shape of the peripheral edge of a saddle base and saddle pad according to one embodiment of the present invention in cross section.

FIG. 8 is a schematic view of a stirrup system.

FIGS. 9a and 9b illustrate a release mechanism for a stirrup system according to FIG. 8.

FIG. 10 shows an example of a runner of sliding type.

FIG. 11 shows an example of a runner of roller type.

FIG. 12 shows another example of a runner of sliding type incorporated in the stirrup system.

### DETAILED DESCRIPTION OF PREFERRED EMBODIMENTS

Throughout this description the terms anatomically correct and anatomically adapted refers to the features that pressure from the saddle is spread evenly over a large area of the horseback, and that the saddle in no way or only to a limited extent interfere with the natural movement of the horse. Furthermore the terms indicate that pressure may be decreased over certain sensible regions if so is needed. Moreover, the term rigid material is used to describe a material that is essentially non flexible as bulk material, but flexible when provided as a thin sheet or the like, ie. the flexibility of a device made of said material can be controlled by varying the material thickness and the shape of the device.

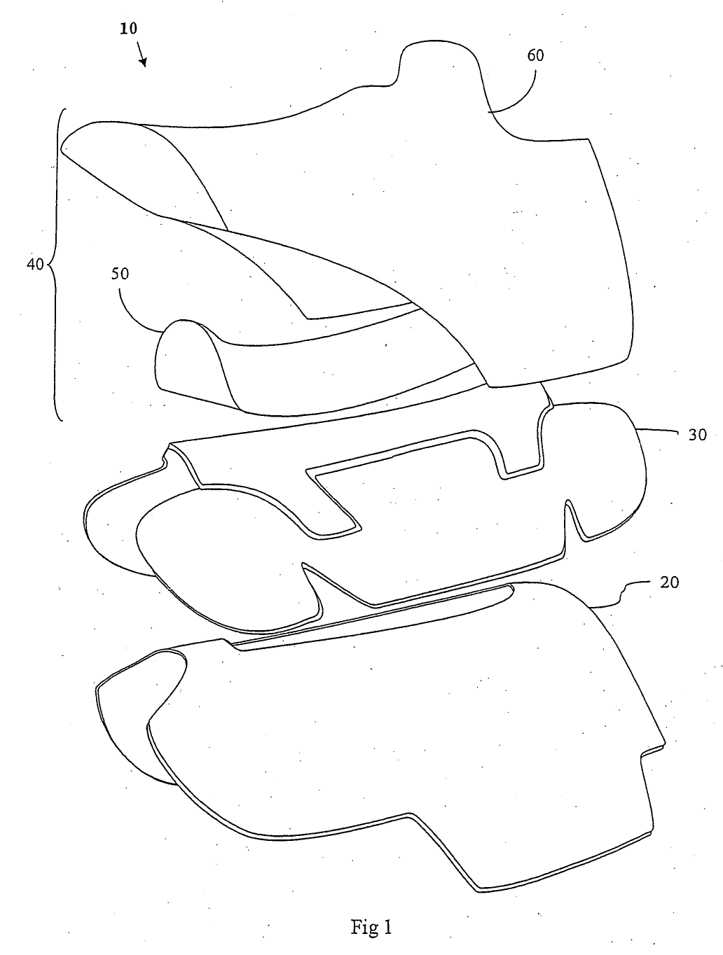

FIG. 1 shows one embodiment of a saddle 10 for horseback riding according to the present invention. The saddle 10 comprises three separate parts and can be seen upon as a modular saddle system. In order from the horseback, the saddle comprises a saddle pad 20, a saddle base 30, and a saddle seat 40. The saddle pad 20 is preferably comprised of a resilient material and is arranged closest to the horse and transfers the pressure from the other parts of the saddle to the horseback. The saddle base 30 is comprised of a rigid material and serves to spread the load from the rider over a large area of the horseback. The saddle pad 20 and the saddle base 30 are preferably adapted to each other such that an anatomically perfect fit on the horseback is achieved. The saddle seat 40 is in turn adapted for optimum riding comfort for the rider and it is detachably attached to the base 30. In the embodiment shown in FIG. 1 the saddle seat 40 comprises a rigid seat base 50 and a seat cover 60 forming the seat surface.

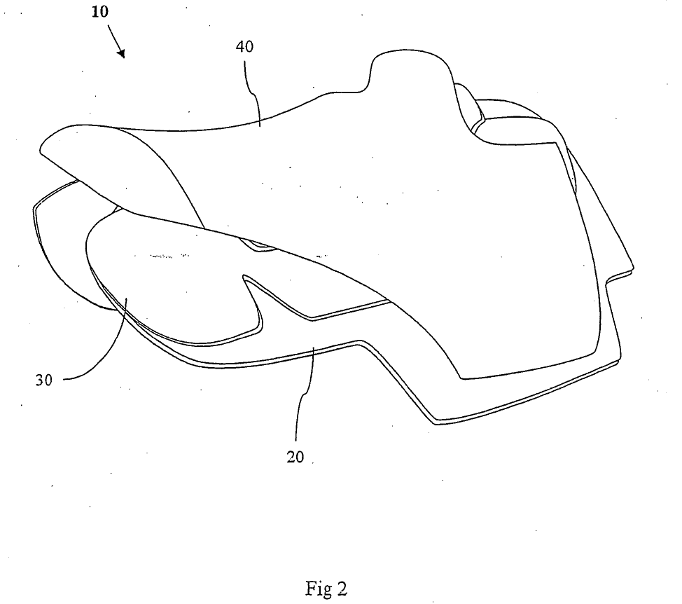

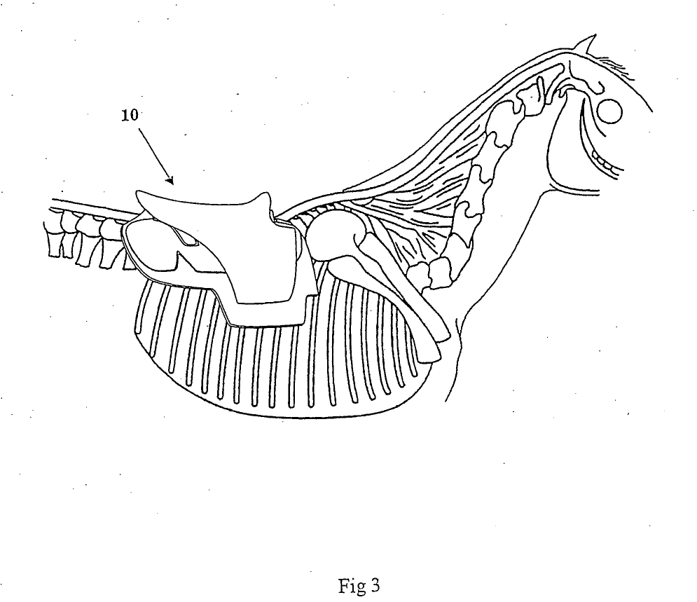

FIG. 2 shows the saddle 10 of FIG. 1 in an assembled state and FIG. 3 shows the assembled saddle 10 arranged on a horseback. The saddle 10 is retained on the horseback by use of conventional girth straps (not shown) that are attached to the saddle base 30. Thus, it is the saddle base 30 that is secured to the horseback and the saddle seat 40 is in turn secured to the saddlebase 30. In this way it is possible to change saddle seat 40 without removing the saddle from the horse. Stirrups (not shown) can also be attached to the saddle base 30 in a conventional manner, but they can also be attached to the saddle seat 40.

One key feature of the saddle 10 of the present invention is that the saddle seat 40 is detachably arranged on the saddle base 30. In this way the saddle base 30 and the padding 20 can be anatomically adapted to a specific horse, while the saddle seat 40 may be substituted to fit different riders, and/or riding disciplines. This concept is especially advantageous in situations where more than two riders frequently ride the same horse, e.g. riding academies and the like, and when the same horse is used for riding different disciplines, e.g. three day event riding. Furthermore it is advantageous for riders who often ride different horses, whereby they will be able to use the same saddle seat 40 on all horses. To achieve this versatility, saddle seats 40 with different seating characteristics can be arranged on the base 30, such that the saddle 10 can be adapted to different riders and/or riding disciplines, and consequently the saddle 10 can be anatomically adapted to more than one horse or type of horse by providing a number of different saddle bases 30 and saddle pads 20 with different characteristics.

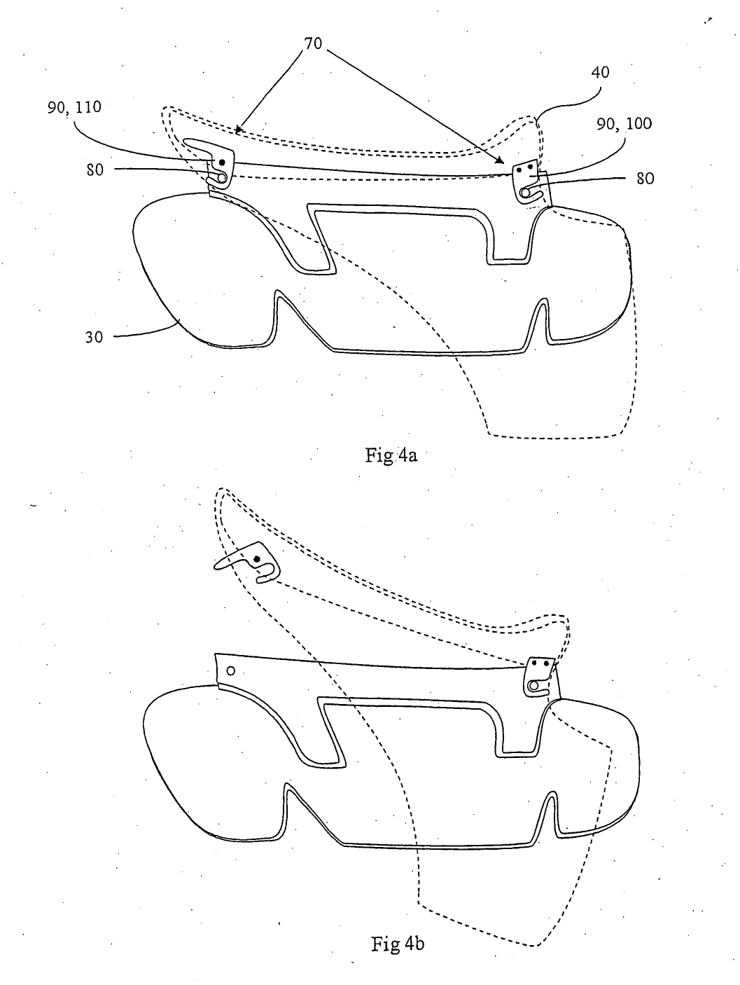

To facilitate the attachment of the saddle seat 40 to the saddle base 30, the seat 40 is retained on the saddle base 30 by a quick fastening system 70, such that the saddle seat 40 easily can be detached/attached from/to the saddle base 30. In FIG. 4a and 4b a schematic example of such a quick fastening system 70 is shown. Preferably, the quick fastening system 70 is comprised of a base structure 80 on the saddle base 30 and a mating structure 90 with a locking mechanism 110 on the saddle seat 40. According to the embodiment of FIG. 4a and 4b the front end of the seat 40 is attached to the base by a hinged coupling 100 and the back end of the seat 40 is attached by a releasable clamp 110. Preferably, the seat 40 is biased with respect to the base by the clamp 110, such that a tight connection is achieved.

By forming the quick fastening system 70 in one standardized size, all available saddle seats 40 can be arranged on all available saddle bases 30, whereby the system becomes extremely easy to adapt to specific situations and easy to upgrade. However, in some cases it is preferred to form the quick fastening system 70 to be limiting, so that only saddle seats 40 that are approved for that specific base 30 can be attached to it, e.g. a saddle base 30 adapted for a small horse such as a Shetland pony may be limited to only accept saddle seats 40 of children size.

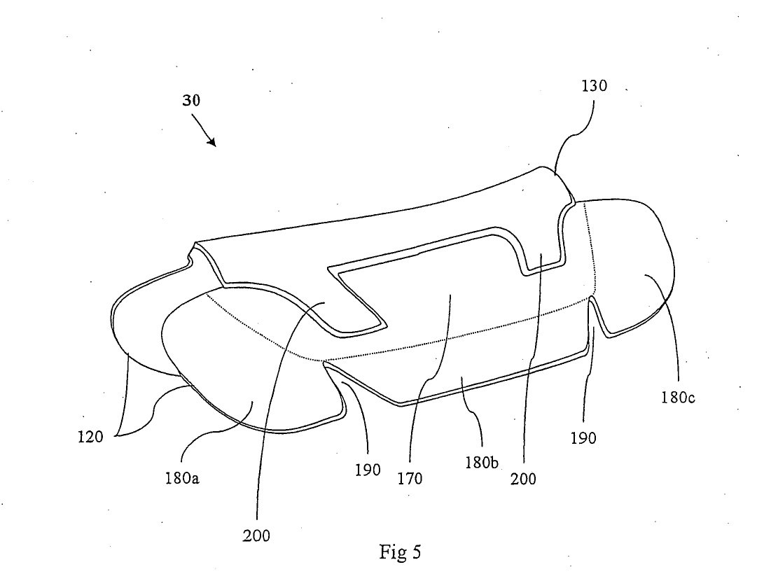

In order for the horseback saddle 10 to be anatomically adapted to the horseback, a new saddle base 30 has been developed, which spreads the pressure from the saddle 10 over a large surface area of the horseback. The saddle base 30 (FIG. 5) is comprised of two pressure distributors 120 that are interconnected by a bridging arrangement 130 that provides clearance over the spinal region.

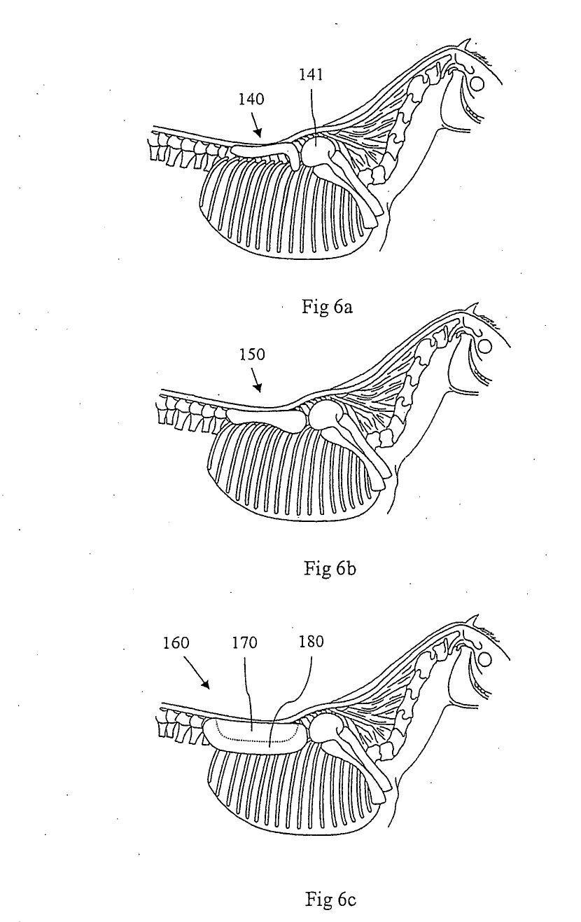

FIGS. 6a to 6c show the pressure distribution areas for a conventional british type saddle (140), western type saddle (150) and the saddle according to the present invention (160), respectively. As can be seen in FIGS. 6a and 6b, conventional saddles mainly rest on the narrow muscle sections on each side of the spinal, and in the case of British saddles also on the region just rear to the scapular 141, as they are provided with stabilizing protrusions that put a large pressure there. However, as is clear form FIG. 6c, the pressure distributors 120 of the saddle base 30 according to the present invention spread the pressure from the saddle 10 over a considerably larger area. In order to achieve a larger pressure distributing area, the pressure distributors 120 each comprises a non flexing portion 170 and peripheral flexing portion 180 that extend over parts of the horseback that move during riding, so that pressure may be applied on a larger area without hindering the natural movements of the horse. In FIG. 6c, the border between the non flexing portion 170 and the flexing portion 180 is illustrated by the dotted line. The central non flexing portion 170 of the pressure distributor 120 can be made essentially rigid or non flexing as that section of the horseback does not move to a large extent during riding.

In one embodiment of the saddle base 30 (FIG. 5) the flexing portion 180 is divided in three independent flexing portions 180 a-c, whereby better flexing characteristics are achieved.

In this way the pressure distributors 120 may be formed to achieve a width to length ratio that is greater than ⅕, preferably greater than ¼, and most preferably greater than ⅓. The desired flexing characteristics of the flexing portion(s) 180 may be achieved in different ways depending on what material the saddle base is formed in. Preferably the saddle base 120 is formed in a thin rigid material such as, a rigid polymer, steel, aluminum or other construction metals, and fiber reinforced composite materials, i.e. carbon, glass, kevlar fiber reinforced polymers. According to one embodiment of the present invention, the base 30 comprising the pressure distributors 120 and the bridging arrangement 130 is integrally formed as one piece. By forming the base as one piece the resulting base 30 will be lightweight and strong at the same time.

Preferably the flexing characteristics for the flexing portion(s) 180 is/are individually controlled by selecting the shape and material characteristics. The flexing action of the flexing portions 180 can be achieved in a number of ways. According to one embodiment the pressure distributors 120 are each provided with at least one flexing notch 190 that separates different flexing portions 180 and controls the flexing of adjacent portions. In the embodiment shown in FIG. 5 each pressure distributor 120 is provided with two flexing notches 190. The position and shape of the flexing notches 190 decide the characteristics of the saddle base pressure distributors 120. The notches 190 are arranged such that the flexible portions 180 of the pressure distributors 120 allow the horse to move in a natural and do not hinder the movement of the horse. The flexing portions 180 may further comprise different material thickness or different material composition for different sections thereof. In one embodiment one or more bending indicators in the form of grooves are formed in the pressure distributor 120 to provide and control the flexing characteristics. In one embodiment, a more flexible material or material composition is comprised in the pressure distributors 120 to create flexing portions 180.

Optionally, the flexing characteristics within each flexing portion 180, 180a, 180b, 180c are controlled so that it follows the movements of the horseback in a natural way. In one embodiment the material thickness of the flexing portions is gradually decreased towards the edge, so that the flexibility is increased towards the edge. The pressure distributors 120 are shaped such that they are anatomically adapted to the horseback, and they may even be formed to match the back of a specific horse to achieve maximum comfort for that horse.

The saddle base 30 according to the invention can also be adapted for production by techniques associated with mass production such as injection molding of polymers and sheet metal pressing, whereby the price of the saddle 10 can be lowered.

The bridging arrangement 130 of the base 30 provides a stiff saddle-section along the spinal of the horse and a relatively wide spinal tunnel that ensures that no pressure is applied on the sensible spinal region. To achieve a stiff bridging arrangement 130, it is preferably essentially continuous along the length of the saddle base 30, but there may be open sections to achieve additional ventilation, lower the weight etc. To avoid an increased pressure load on the horseback close to the spinal, the bridging arrangement preferably has at least one stiffener 200 that extends over a section of the pressure distributor 120 on each side of the spinal. In one embodiment the bridging arrangement 130 is provided with two stiffeners 200 on each side, the first in the front region of the saddle base 30 and the other in the rear region of the saddle base 30. However, the stiffening action may also be achieved e.g. by increasing the material thickness in the bridging arrangement 130 and the sections of the pressure distributors 120 that are close to the spinal, etc.

The saddle base 30 is further provided with coupling means 80 for the detachable saddle seat 40. As is described above, these coupling means 80 preferably are in the form of one side of a mating quick fastening system 70. The coupling means 80 may either be integrated in the design of the saddle base 30 or attached to it by any suitable means for fastening.

According to one embodiment of the present invention, the saddle seat 40 comprises a rigid seat base 50 that is provided with complementary coupling means 100, 110 for detachable fastening of the same to the saddle base 30. The complementary coupling means 100, 110 may be formed integrally in the seat base 50 or they may be attached to it by any suitable means for fastening. The seat base 50 can be made of a molded polymer material, a fiber reinforced material, a pressed or molded metal, e.g. In one embodiment the seat base 50 has the form of a frame that is integrated in a molded flexible material forming the seat cover 60.

The seat cover 60 forms the surface on which the rider sits during riding. The seat cover 60 may e.g. be a thin cover of leather, synthetic leather or the like. But it may also be of resilient nature, such as a padded leather cover, or a molded polymer cover with a smooth surface, etc. Preferably the area of the cover 60 that is used as seating area during riding is provided as one piece, without seams or the like. Like conventional saddles the saddle cover 60 comprises flaps that extend along the sides of the horse.

The saddle pad 20 is formed to fill the space between the saddle base 30 and the horseback so that an anatomically correct load is applied on the horseback. In one embodiment of the invention wherein the saddle base 30 is provided in a limited number of sizes, a number of saddle pads 20 with different thickness profiles may be provided to allow fine adjustment of the saddle size to fit a specific horse. The padding 20 is formed in a resilient material, such as a foamed polymer, sheep wool, flax and the like. Furthermore the saddle pad 20 may be formed so that reduced or no pressure is applied on certain regions of the horseback, e.g. such that less pressure is applied on an injured muscle. Preferably the saddle pad 20 also comprises air and/or sweat channels.

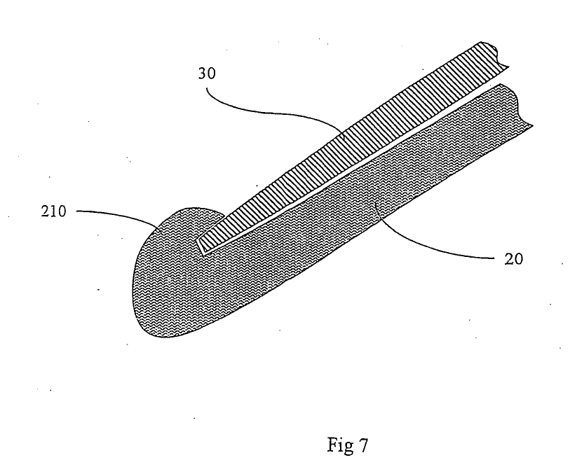

The saddle pad 20 can be provided with fastening means to secure it relative to the saddle base 30, so that their relative position do not change during riding, and so that they become easier to handle. In one embodiment, shown in FIG. 7, at least a section of the peripheral edge of the saddle pad 20 is formed as a clasping edge 210 that clasps the peripheral edge of the saddle base 30. The clasping section 210 further assures that the relative thin and sharp edges of the saddle base 30 never comes in contact with the horseback.

In order to achieve full potential of the saddle 10 according to the present invention there has been developed a method of providing a saddle that is anatomically correct for a specific horse and rider combination. In a general form the method comprises the steps of: providing a saddle base 30 that is anatomically correct for the horse; providing an, for the rider, anatomically correct saddle seat 40; and detachably arranging the saddle seat 40 onto the saddle base 30. The method may also comprise the step of providing an, for the horse, anatomically correct saddle pad 20.

Preferably, each component of the saddle according to the present invention is provided in a number of sizes and/or types, thereby defining e.g. a set of saddle bases 30 of different sizes, a set of saddle seats 40 of different sizes and/or adapted for different riding disciplines. Therefore the step of providing a saddle base involves selecting from a set of saddle bases 30 an, for the horse, anatomically correct saddle base 30; the step of providing a saddle seat 40 involves selecting from a set of saddle seats 40 an, for the horse, anatomically correct saddle seat 40; and, the step of providing a saddle pad 20 involves selecting from a set of saddle pads 20 an, for the horse, anatomically correct saddle pad 20.

In another embodiment of the present invention, the saddle base 30 and/or the pad 20 are formed to fit the back of the specific horse. In this case the step of providing a saddle base 30 involves forming the saddle base 30 to fit the back of the specific horse; and the step of providing a saddle pad 20 involves forming the saddle pad 20 to fit the back of the specific horse.

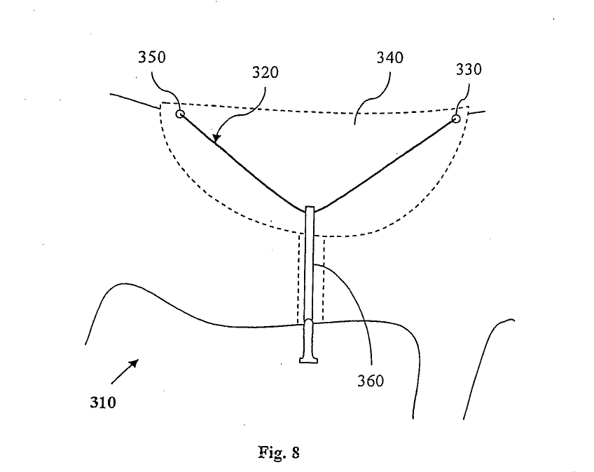

As mentioned above, conventional saddles have stirrups that are attached to the saddle frame in the front region of the saddle. Such arrangements give rise to highly concentrated point loads on the horseback. To avoid such point loads, the present saddle is preferably provided with a stirrup system that spreads the load from the stirrups along the full length of the saddle. FIG. 8 shows a schematic view of one embodiment of such a stirrup system 310, wherein a guide 320 extends from a front end region 330 of a saddle 340 to a rear end region 350 of the saddle 340 and a stirrup 360 is supported by and allowed to move along the guide 320. By this arrangement the pressure form a load on the stirrup 360 is spread in the above manner.

In one embodiment the guide 320 is a bendable element that is supported by the saddle 340 at the front end region 330 and the rear end region 350 thereof, and the guide element 320 is essentially longer than the closest distance between the front end region 330 and the rear end region 350, such that the guide 320 assumes a V shape with the stirrup 360 supported in the bending point, as is shown in FIG. 1. In this embodiment the guide 320 is formed by a rope, band, cord, wire or the like that is attached to the saddle 340 or the saddle frame at a front fixing point 330 and a rear fixing point 350. Preferably, the guide 320 is a bendable element with a smooth surface, such as a rope or wire with a smooth tubular mantle.

As the guide 320 is arranged between the horseback and the leg of the rider, it should be designed such that it is relatively thin, and such that it does not create point pressure on the side of the horseback, e.g. when the rider applies weight on the stirrups 360 or when he/she applies a pressure on the side of the horseback with his/her legs. To achieve best performance for the rider as well as the horse, the saddle 340 preferably is arranged to house the guide 320 and stirrup 360 arrangement, especially at the supporting section along the guide 320. The saddle 340 may e.g. have a recess that accommodates the guide 320 and stirrup 360 arrangement.

Preferably the stirrup system 310 comprises a shield between the guide 320 and stirrup 360 arrangement and the horseback, to prevent wearing action on the horseback. The shield may be formed as a portion of the saddle 340, and can be formed such that it provides low friction for the movement of the stirrup 360 along the guide 320. Furthermore the shield can be provided with movement restricting formations, which prevents the stirrup 360 to move beyond a certain limit along the guide 320. Alternatively, movement restricting formations can be arranged directly on the guide 320, preferably in the form of moveable clips or the like.

Preferably the front fixing point 330 is formed such that the length of the guide 320 is adjustable, whereby the height of the stirrup 360 easily can be adjusted. The adjustable front fixing point 330 may have the form of a buckle of the type disclosed in U.S. Pat. No. 4,881,303, whereby the front end portion of the guide 320 has a flat, band like shape, or it may be of rope/wire locking type. The important aspect is that the fixing point 330 is simple to unlock and relock, such that the height of the stirrup 360 can be adjusted in a simple manner. To facilitate correct height adjustments, the guide 320 can be provided with markings indicative of the stirrup 360 height. Such markings may be in the form of different colored segments on the adjustable section of the guide 320 or the like.

In another embodiment the adjustable front fixing point 330 is of reel-type, whereby the adjustable section of the bendable guide element 320 is rolled onto a reel. To adjust the height of the stirrup 360 the rider simply rotates the reel in the desired direction, and then locks the reel in the desired position. By this arrangement, a highly adjustable and convenient stirrup system 310 is achieved.

In still another embodiment the rear fixing point 350 is arranged at the longitudinal centre of the saddle 340, and the guides 320 from both sides of the saddle 340 are attached to the same rear fixing point 350.

Furthermore the guides 320 can be attached to the rear fixing point 350 by a release mechanism arranged to release the guides 320 when a rider falls off the horse, whereby the stirrups 360 are free to move past the lose ends of the guides 320 and thus can be detached from the same. Preferably the release mechanism comprises a releasing actuator connected to the rider, which actuator actuates the release mechanism to release the guides when the rider falls off the horse. The actuator is attached to the rider by a safety cord that is attached to the rider in a suitable way. It is important that the safety cord is attached to the rider such that he/she not is hindered in any way.

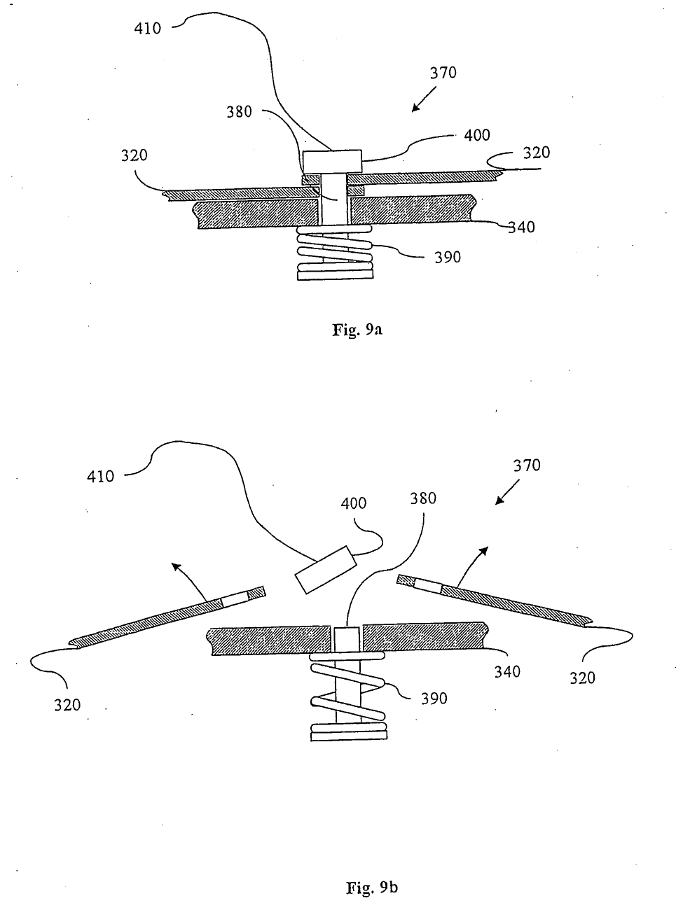

FIGS. 9a and 9b schematically shows a schematic example of a release mechanism 370, which is comprised of a pin 380 having a projecting and a retracted position, the pin 380 is biased in the retracted direction by a spring 390, and when in the projecting position, the pin 380 is arranged to retain the guides 320 in fixed position. The pin 380 is kept in the projecting position by an actuator 400 connected to the rider by a safety cord 410, and when the actuator 400 is removed, by a rider falling off the horse, the pin 380 moves to the retracted position by the force of the biasing spring 390. When the pin 380 is retracted, the guides 320 are released and the stirrups 360 are detached from the guides 320.

According to another embodiment the release mechanism is arranged on the stirrup 360 that is supported by the guide 320.

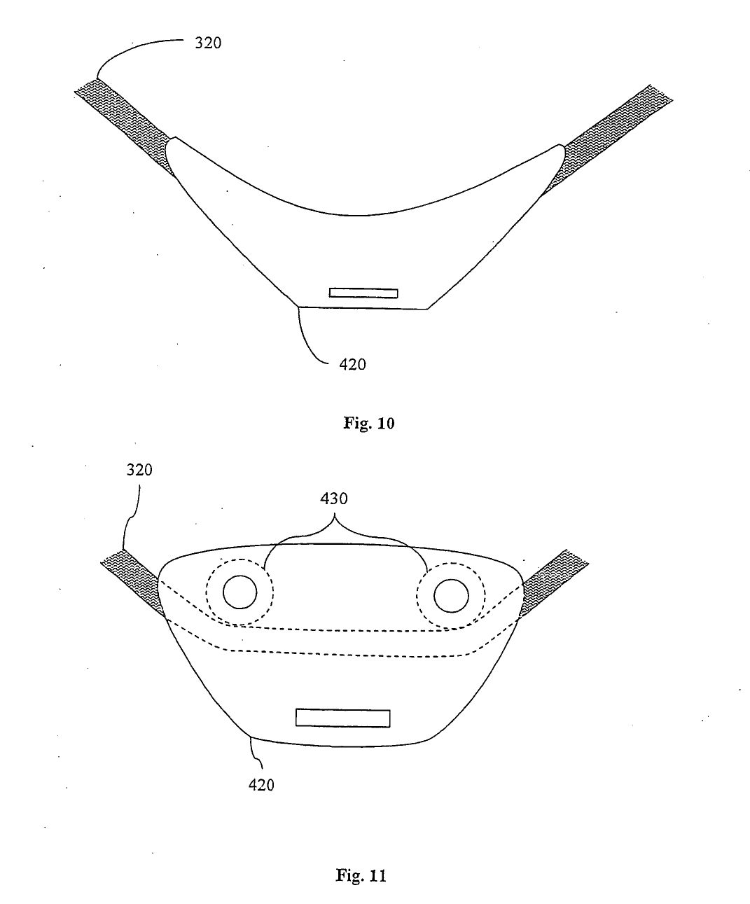

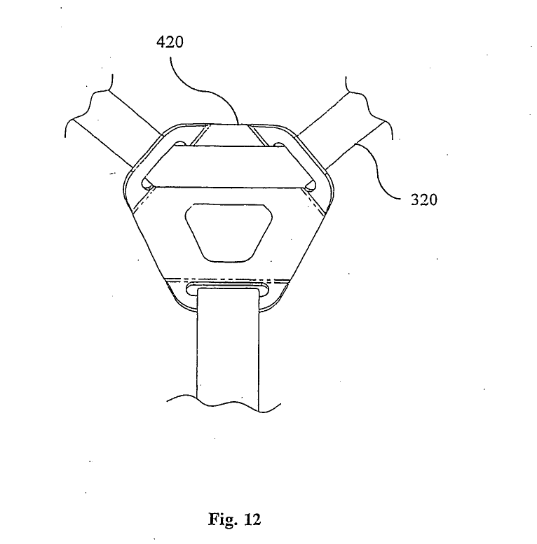

The stirrup 360 can be supported to move on the guide 320 in many ways, According to one embodiment, the stirrup 360 is supported on the guide by a runner 420. To achieve smooth movement of the runner, it can be formed such that it can perform a sliding movement along the guide (FIG. 10), or the runner 420 can be provided with at least one running-wheel 430 for rolling movement along the guide (FIG. 11).

To avoid excessive movements by the runner 420 along the guide 320, the movement of the runner 420 along the guide 320 preferably is damped. One way of achieving a damped movement is to form the runner 420 such that a bendable guide 320 passes through the runner 420 along a crooked path, whereby the movement is damped by the bending of the guide 320. Another way is to provide a runner 420 of roller type with damped rollers 430.

The characteristics for the movement of the runner 420 or stirrup 360 along the guide 320 depend on parameters such as the friction between the runner 420 and the guide 320, the bendability of the guide 320, and the angle of the guide 320 at the bending point. In one embodiment, one or more of these parameters are varied along the length of the guide 320, thus providing different characteristics depending on the position of the runner 420 on the guide 320. Examples of such designs comprise, use of a guide 320 with varying thickness, different surface properties, that a bendable guide 320 is provided with less bendable portions and the like.

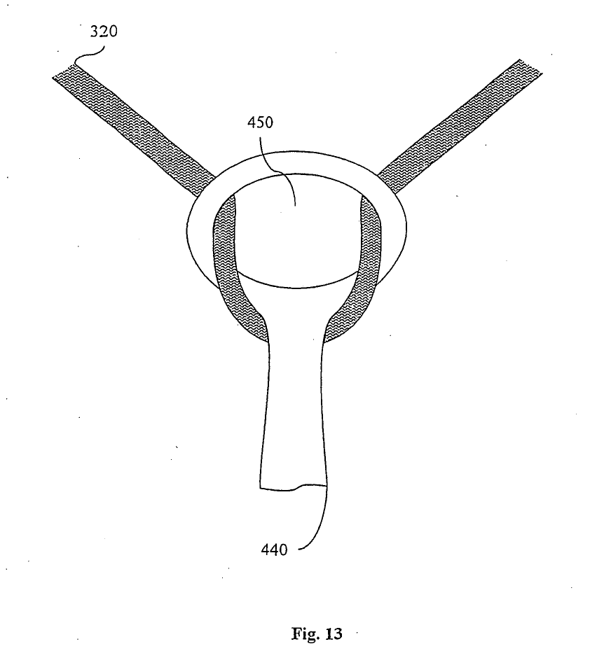

FIG. 12 shows an illustrative example of a runner 420 for a band type guide.

Preferably the runner 420 is formed such that it can be detached from the guide 320 without the need of releasing any part of the guide 320 from the saddle 340. One example of a detachable runner 440 is shown in FIG. 13 wherein a loop of the guide 320 is inserted into an opening 450 in the runner 440, and the lower end of the runner in turn is inserted into the guide 320 loop such that they are interlooped with respect to each other. This type of detachable runner 440 is well known in the field of rock climbing equipment, and is often referred to as an 8 shaped descender. An advantage with this interlooped runner 440 is that the guide path indeed is crooked and thus damped. Furthermore the interloped runner 440 can be made from one single piece of material, and thus become extremely reliable. The damping characteristics of such runners 440 can be adjusted by altering the shape of the interloop section to control the bending of the guide 320.

The stirrup can be attached to the guide 320 or the runner 420, 440 by a more or less conventional stirrup strap, which further can be adjustable. Alternatively, the stirrup 360 and the runner 420, 440 are directly attached to each other by a firm or flexible coupling, whereby the stirrup strap is eliminated. The stirrup 360 and runner 420, 440 may even be formed as one unit.

In still another embodiment, the guide 320 is a curved rigid element that is supported by the saddle by at least two fixing points 330, 350. A rigid type guide 320 may be of rail type whereby a runner encloses or partly encloses the rail. Alternatively the rigid type guide 320 may be a groove type guide whereby a runner is partly enclosed by the guide.

1. Saddle (10) for horseback riding, comprising a saddle base (30) that is anatomically adapted to the horseback, and a saddle seat (40), the saddle seat (40) is detachably arranged on the saddle base (30) characterized in that the saddle base (30) is arranged to be secured on the horseback and that the saddle seat (40) is arranged to be secured to the saddle base (30).

2. Saddle (10) according to claim 1 characterized in that the saddle seat (40) is retained on the saddle base (30) by a quick fastening system (70), such that the saddle seat (40) easily can be detached/attached from/to the saddle base (30).

3. Saddle (10) according to claim 2 characterized in that the quick fastening system (70) is comprised of a base structure (80) on the saddle base (30), and a mating structure (90) with a locking mechanism (110) on the saddle seat (40).

4. Saddle (10) according to claim 1 characterized in that saddle seats (40) with different seating characteristics can be arranged on the base (30), such that the saddle (10) can be adapted to different riders and/or riding disciplines.

5. Saddle (10) according to claim 1 characterized in that the saddle (10) can be anatomically adapted to more than one horse or type of horse by providing a number of different saddle bases (30) with different characteristics.

6. Saddle base (30) for a horseback saddle (10), comprising two pressure distributors (120) that are interconnected by a bridging arrangement (130) that provides clearance over the spinal region, characterized in that each pressure distributor (120) comprises a non flexible section (170) and a peripheral flexing portion (180, 180a, 180b, 180c).

7. Saddle base (30) according to claim 6 characterized in that each flexing portion (180) is divided into two or more individual flexing portions (180a, 180b, 180c) by at least one flexing notch (190).

8. Saddle base (30) according to claim 6 characterized in that the bridging arrangement (130) on each side is provided with at least one stiffener (200) that extends over a section the pressure distributor (120).

9. Saddle base (30) according to claim 6 characterized in that the bridging arrangement (130) on each side is provided with two stiffeners (200), the first in the front region of the base and the other in the rear region.

10. Saddle base according to claim 6 characterized in that the bridging arrangement is essentially continuous along the length of the base.

11. Saddle base (30) according to claim 6 characterized in that each pressure distributor (120) has a width to length ratio that is greater than ⅕, preferably greater than ¼, and most preferably greater than ⅓.

12. Saddle base (30) according to claim 6 characterized in that the pressure distributors (120) and the bridging arrangement (130) are integrally formed as one piece.

13. Saddle base (30) according to claim 6 characterized in that it is formed in a fiber reinforced composite material.

14. Saddle base (30) according to claim 13 characterized in that the fibers are chosen from the group of carbon, glass, and kevlar fibers.

15. Saddle base (30) according to claim 6 characterized in that that it is formed by injection molding a polymeric material.

16. Saddle base (30) according to claim 6 characterized in that it is comprised of a pressed sheet metal.

17. Saddle base (30) according to claim 6 characterized in that it is provided with fastening structures (80) for a detachable saddle seat (40).

18. Saddle seat (40) for a horseback saddle (10) characterized in that it is provided with fastening structures (90, 100, 110) for detachable fastening of the same to a saddle base (30).

19. Saddle seat (40) according to claim 18 characterized in that the saddle seat comprises a rigid seat base (50).

20. Saddle pad (40) for a horseback saddle (10) characterized in that at least a section of the peripheral edge of the saddle pad (20) is formed as a clasping edge (210) that is arranged to clasp the peripheral edge of a saddle base (30) according to claim 6.

21. Method of providing a saddle (10) for a specific horse and rider combination, characterized by the steps: providing a saddle base (30) that is of suitable size for the horse, providing an, for the rider, suitable saddle seat (40), and detachably arranging the saddle seat (40) onto the saddle base (30).

22. Method of providing a saddle (10) according to claim 21 characterized in that it comprises the additional step of: providing an, for the horse, saddle pad (20) that fit in between the saddle base and the horseback.

23. Method of providing a saddle (10) according to claim 21 characterized in that the step of providing a saddle base (30) comprises: selecting from a set of saddle bases (30) a saddle base (30) of suitable size for the horse.

24. Method of providing a saddle (10) according to claim 21 characterized in that the step of providing a saddle base (30) comprises: forming the saddle base (30) to fit the back of the specific horse.

25. Method of providing a saddle (10) according to claim 21, characterized in that the step of providing a saddle seat (40) comprises: selecting from a set of saddle seats (40) a saddle seat (40) that fits the rider.

26. Method of providing a saddle (10) according to claim 21, characterized in that the step of providing a saddle pad (20) comprises: selecting from a set of saddle pads (20) a saddle pad (20) that fit in between the saddle base and the horseback.

27. Method of providing a saddle (10) according to claim 21, characterized in that the step of providing a saddle pad (20) comprises: forming the saddle pad (20) to fit the back of the specific horse.

28. Saddle (10) according to claim 1 characterized in that the saddle (10) with a stirrup system comprising a guide (320) extending from a front end region (330) of the saddle (340) to a rear end region (350) of the saddle (340); and a stirrup (360) that is supported by and allowed to move along the guide (320).

29. Saddle (10) according to claim 28 characterized in that the guide (320) is a bendable element that is supported by the saddle (340) at the front end region (330) and at the rear end region (350) thereof, and that the guide element (320) is essentially longer than the shortest distance between the front end region (330) and the rear end region (350).

30. Saddle (10) according to claim 28 characterized in that the guide (320) is supported by a front fixing point (330) and a rear fixing point (350), wherein the front fixing point (330) is formed such that the length of the guide (320) is adjustable, whereby the height of the stirrup (360) can be adjusted.

31. Saddle (10) according to claim 28 characterized in that the rear fixing point (350) is arranged at the longitudinal centre of the saddle (340), and that the guides (320) from both sides of the saddle (340) are attached to the same rear fixing point (350).

32. Saddle (10) according to claim 28 characterized in that the guide(s) (320) is(are) attached to the rear fixing point (350) by a release mechanism (370) arranged to release the guide (320) when a rider falls off the horse, whereby the stirrup (360) is free to move past the lose end of the guide (320) and thus can be detached from the same.

33. Saddle (10) according to claim 28 characterized in that the stirrup (360) is supported on the guide by a runner (420, 440).

34. Saddle (10) according claim 33 characterized in that the movement of the runner (420, 440) along the guide (320) is damped.

35. Saddle (10) according to 33 characterized in that the stirrup (360) and the runner (420, 440) are formed as one unit.
